(19) United States
(12) Patent Application Publication
(10) Pub. No.: US 2023/0025991 A1
(43) Pub. Date: Jan. 26, 2023

(54) INFORMATION PROCESSING APPARATUS, METHOD, AND VEHICLE

(71) Applicant: TOYOTA JIDOSHA KABUSHIKI KAISHA, Toyota-shi (JP)

(72) Inventor: Makoto HONDA, Tokyo-to (JP)

(73) Assignee: TOYOTA JIDOSHA KABUSHIKI KAISHA, Toyota-shi (JP)

(21) Appl. No.: 17/829,609

(22) Filed: Jun. 1, 2022

(30) Foreign Application Priority Data
Jul. 21, 2021 (JP) 2021-120685

(51) Int. Cl. B60W 60/00; B60W 50/14; B60W 50/10; B60W 40/09

(52) U.S. Cl. CPC B60W 60/0053; B60W 50/14; B60W 50/10; B60W 40/09; B60W 2050/146; B60W 2540/21; B60W 2540/30

(57) ABSTRACT

An information processing apparatus detects occurrence of a request to switch to manual driving during autonomous driving control of a first vehicle, acquires an utterance of a driver in a case where there is occurrence of the request to switch to manual driving, and presents, to the driver, a part of an explanation about a reason for occurrence of the request to switch to manual driving according to the utterance of the driver.

### CROSS REFERENCE TO RELATED APPLICATION

This application claims the benefit of Japanese Patent Application No. 2021-120685, filed on Jul. 21, 2021, which is hereby incorporated by reference herein in its entirety.

### BACKGROUND

### Technical Field

The present disclosure relates to an information processing apparatus, a method, and a vehicle.

### Description of the Related Art

There is disclosed an autonomous driving support system that acquires, in a case where it is determined that autonomous driving control is disabled, a reason why autonomous driving control is disabled, and that issues a notification indicating that autonomous driving control is disabled and the reason therefor (for example, Patent Document 1).
[Patent Document 1] Japanese Patent Laid-Open No 2016-028927

An aspect of the disclosure is aimed at providing an information processing apparatus, a method, and a vehicle with which a sense of discomfort felt by a driver may be reduced at a time when a notification of switching from autonomous driving control to manual driving control is issued.

An aspect of the present disclosure is an information processing apparatus including a processor that:
detects occurrence of a request to switch to manual driving during autonomous driving control of a first vehicle, and
presents, in a case where there is occurrence of the request, a part of an explanation about a reason for occurrence of the request, to a driver of the first vehicle.

Another aspect of the present disclosure is a method performed by an information processing apparatus, the method including:
detecting occurrence of a request to switch to manual driving during autonomous driving control of a first vehicle; and
presenting, in a case where there is occurrence of the request, a part of an explanation about a reason for occurrence of the request, to a driver of the first vehicle.

Another aspect of the present disclosure is a vehicle including a processor that:
detects occurrence of a request to switch to manual driving during autonomous driving control of a first vehicle, and
presents, in a case where there is occurrence of the request, a part of an explanation about a reason for occurrence of the request, to a driver of the first vehicle.

According to an aspect of the present disclosure, a sense of discomfort felt by a driver may be reduced at a time when a notification of switching from autonomous driving control to manual driving control is issued.

### BRIEF DESCRIPTION OF THE DRAWINGS

FIG. 1 is a diagram illustrating an example system configuration of a takeover notification system and an example system configuration of a vehicle according to a first embodiment;

FIG. 2 is an example of a hardware configuration of the multimedia ECU;

FIG. 3 is a diagram illustrating an example of a functional configuration of the vehicle and the center server;

FIG. 4 is an example of the intent number table;

FIG. 5 is a diagram illustrating an example of a dialogue scenario that arises in relation to explanation of the reason for occurrence of a takeover request;

FIG. 6 is an example of the correspondence table for the dialogue level 1 for the case where the cause of occurrence of the takeover request is difficulty in reception of the GNSS signal;

FIG. 7 is an example of the correspondence table for the dialogue level 2 for the case where the cause of occurrence of the takeover request is difficulty in reception of the GNSS signal;

FIG. 8 is an example of the correspondence table for the dialogue level 3 for the case where the cause of occurrence of the takeover request is difficulty in reception of the GNSS signal;

FIG. 9 is an example of the correspondence table for the dialogue level 4 for the case where the cause of occurrence of the takeover request is difficulty in reception of the GNSS signal;

FIG. 10 is an example of a flowchart of a takeover notification process by the vehicle according to the first embodiment;

FIG. 11 is an example of a flowchart of a takeover notification process by the center server according to the first embodiment;

FIG. 12 is an example of a time chart related to download of the correspondence table group and the dialogue process;

FIG. 13 is an example of a time chart related to download of the correspondence table group and the dialogue process;

FIG. 14 is a diagram illustrating an example of a functional configuration of a vehicle and a center server according to the second embodiment;

FIG. 15 is an example of a flowchart of the takeover notification process by the vehicle according to the second embodiment; and

FIG. 16 is an example of a flowchart of the takeover notification process by the center server according to the second embodiment.

### DESCRIPTION OF THE EMBODIMENTS

In relation to a vehicle that travels while switching between an autonomous driving mode and a manual driving mode, switching from the autonomous driving mode to the manual driving mode is referred to as takeover. A driver who has a long experience driving such a vehicle learns through experience in what situation a takeover request occurs. A takeover request is a request to the driver to switch from autonomous driving to manual driving. Whether a driver wants to know the reason for the takeover request may depend on his/her personality, mood, or a driving state. For example, in the case where a driver is driving the same autonomous driving vehicle for years and knows conditions for occurrence of the takeover request, or in the case where the driver is listening to music in the autonomous driving vehicle, or in the case where the driver is talking with a passenger, a notification of the reason for occurrence of the takeover request may seem annoying. However, there may be a case where the driver wants to know the details of the reason for occurrence of the takeover request.

An aspect of the present disclosure is an information processing apparatus including a processor that is configured to present, in a case where there is occurrence of a request to switch to manual driving during autonomous driving control of a first vehicle, a part of an explanation about a reason for occurrence of the request, to a driver of the first vehicle. For example, the information processing apparatus may be an electronic control unit (ECU) or an on-board unit mounted in the first vehicle. However, the information processing apparatus may alternatively be a server that is capable of communicating with the first vehicle, without being limited to the examples mentioned above. The processor is a processor such as a central processing unit (CPU), for example. A method of presenting the reason for occurrence of the request to switch to manual driving may be output of audio from a speaker in the first vehicle, or may be output of a message on a display in the first vehicle, for example. The request to switch to manual driving may sometimes be referred to as a takeover request.

According to the aspect of the present disclosure, in the case where there is occurrence of the request to switch to manual driving during autonomous driving control, a part, not all, of the explanation about the reason for occurrence of the request is presented, and a sense of discomfort felt by the driver may be reduced.

In the aspect of the present disclosure, the processor may acquire an utterance of the driver of the first vehicle in a case where there is occurrence of the request. In this case, the processor may present, to the driver, a part of the explanation about the reason for occurrence of the request according to the utterance of the driver. The utterance of the driver is acquired by a speech recognition process, for example. The utterance of the driver reflects a level of interest, of the driver, in the explanation about the reason for occurrence of the request to switch to manual driving. For example, in the case where the driver wants to know the reason for occurrence of the request, this is indicated in the utterance of the driver, and a more detailed explanation will be presented. For example, in the case where the driver is not interested in the reason for occurrence of the request, this is reflected in the utterance of the driver, and a simple explanation will be presented. Accordingly, in the aspect of the present disclosure, an explanation is presented according to the level of interest, of the driver, in the explanation about the reason for occurrence of the request to switch to manual driving.

In the aspect of the present disclosure, the information processing apparatus may further include a storage that stores an association between a first utterance and a part of the explanation about the reason for occurrence of the request. In the case where the utterance of the driver is at least similar to the first utterance, the processor may present, to the driver, the part of the explanation about the reason for occurrence of the request that is associated with the first utterance. To be at least similar may mean that the utterance of the driver is similar to the first utterance, or that the utterance of the driver matches the first utterance. The information processing apparatus may reduce a delay in response to the utterance of the driver by holding an association between an utterance that is expected in advance and a part of the explanation about the reason for occurrence of the request as an answer to the utterance mentioned above.

In the aspect of the present disclosure, the information processing apparatus may be mounted in the first vehicle. That is, the information processing apparatus may be one of a plurality of ECUs or an on-board unit mounted in the first vehicle. In a case where there is occurrence of the request, the processor may download from a predetermined apparatus, and store in the storage, an association between the utterance of the driver and a part of the explanation about the reason for occurrence of the request. Accordingly, because an association between the utterance of the driver and a part of the explanation about the reason for occurrence of the request may be downloaded and stored in the storage as needed, resources in the storage may be effectively used.

In the aspect of the present disclosure, the processor may further acquire a cause of occurrence of the request. Furthermore, the processor may download the association, corresponding to the cause of occurrence of the request, between the utterance of the driver and a part of the explanation about the reason for occurrence of the request. Accordingly, associations other than the association corresponding to the cause of occurrence of the request to switch to manual driving do not have to be downloaded, and it is possible to save on communication bandwidth and a memory capacity of the storage.

Furthermore, the processor may collectively download, from a predetermined apparatus, the association, corresponding to the cause of occurrence of the request to switch to manual driving, between the utterance of the driver and a part of the explanation about the reason for occurrence of the request. Accordingly, in a case where the driver makes an utterance several times, a response speed for each utterance may be increased.

The association between the utterance of the driver and a part of the explanation about the reason for occurrence of the request may include a first association and at least one second association. The first association associates a plurality of second utterances that are expected in a case of asking the cause of occurrence of the request to switch to manual driving, with the cause of occurrence of the request as a part of the explanation about the reason for occurrence of the request. The second association associates a plurality of third utterances each including a question that is expected to further arise when the cause of occurrence of the request is presented, with an answer to the question as a part of the explanation about the reason for occurrence of the request.

In this case, the processor may present to the driver, after occurrence of the request, the cause of occurrence of the request that is associated with the second utterance that is similar to an utterance of the driver, by referring to the first association. Furthermore, the processor may present to the driver, after presenting the cause of occurrence of the request to the driver, the answer to the question that is associated with the third utterance that is similar to an utterance of the driver, by referring to the at least one second association. Accordingly, the explanation about the reason for occurrence of the request to switch to manual driving may be presented to the driver step by step.

In the aspect of the present disclosure, the information processing apparatus may be mounted in the first vehicle. The processor may further transmit the utterance of the driver to a predetermined apparatus, and receive, from the predetermined apparatus, a part of the explanation about the reason for occurrence of the request according to the utterance of the driver. The information processing apparatus may thus receive a part of the explanation about the reason for occurrence of the request to switch to the manual driving, according to the utterance of the driver, from the predetermined apparatus, and use of a storage area in a memory may be reduced.

In the aspect of the present disclosure, the processor may repeatedly perform a process of acquiring the utterance of the driver and presenting a part of the explanation about the reason for occurrence of the request according to the utterance, until the driver starts manual driving. Whether manual driving is started by the driver is detected based on a captured image from a camera that is installed in the first vehicle or by monitoring steering wheel operation, for example. In the aspect of the present disclosure, the processor may repeatedly perform a process of acquiring the utterance of the driver and presenting a part of the explanation about the reason for occurrence of the request according to the utterance, until acceptance of switching to manual driving is indicated by the utterance of the driver. A process of presenting a part of the explanation about the reason for occurrence of the request to switch may thus be ended at the time of switching from autonomous driving to the manual driving.

Another aspect of the present disclosure may be identified as a method that is performed by the information processing apparatus described above. The method is performed by the information processing apparatus, and includes detecting occurrence of a request to switch to manual driving during autonomous driving control of a first vehicle; and presenting, in a case where there is occurrence of the request, a part of an explanation about a reason for occurrence of the request, to a driver of the first vehicle. Furthermore, other aspects of the present disclosure may be identified as a program for causing a computer to perform the method described above, and a non-transitory computer-readable storage medium storing the program. Moreover, another aspect of the present disclosure may be identified as a vehicle including the information processing apparatus described above.

In the following, embodiments of the present disclosure will be described with reference to the drawings. The configuration of the embodiments described below are examples, and the present disclosure is not limited to the configuration of the embodiments.

### First Embodiment

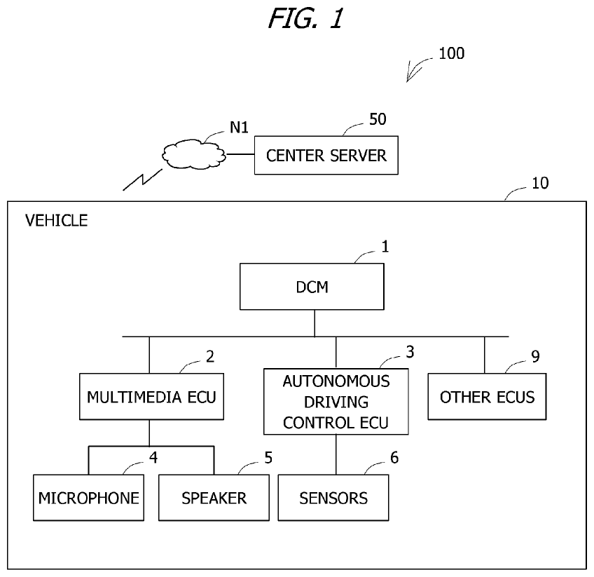

FIG. 1 is a diagram illustrating an example system configuration of a takeover notification system 100 and an example system configuration of a vehicle 10 according to a first embodiment. The takeover notification system 100 is a system for notifying a driver of the vehicle 10 of switching to manual driving, when a request to switch from autonomous driving to manual driving occurs in the vehicle 10. Switching of the vehicle 10 from autonomous driving to manual driving is referred to as takeover.

The takeover notification system 100 includes the vehicle 10 and a center server 50. The vehicle 10 is a connected vehicle including a data communication module (DCM) 1 that is capable of communication. The vehicle 10 is a vehicle that travels while switching between an autonomous driving mode and a manual driving mode. The vehicle 10 may be driven by an engine or may be driven by a motor. The vehicle 10 is an example of “first vehicle”.

The center server 50 is a server that supports autonomous driving control of the vehicle 10, and that provides predetermined services to the vehicle 10 through communication. The vehicle 10 and the center server 50 are capable of communicating with each other via a network N1. The network N1 is the Internet, for example. The DCM 1 of the vehicle 10 connects to a wireless network by a mobile wireless communication method such as long term evolution (LTE), 5th Generation (5G) or 6th Generation (6G), or a wireless communication method such as Wi-Fi or DSCR, for example, and connects to the Internet via the wireless network.

The vehicle 10 includes the DCM 1, a multimedia ECU 2, an autonomous driving control ECU 3, a microphone 4, a speaker 5, sensors 6, and other ECUs 9. Additionally, in FIG. 1, devices related to a process according to the first embodiment are extracted and illustrated as a system configuration of the vehicle 10, and the system configuration of the vehicle 10 is not limited to the one illustrated in FIG. 1.

The DCM 1, the multimedia ECU 2, the autonomous driving control ECU 3, and the other ECUs 9 are connected via controller area network (CAN) or Ethernet (registered trademark) network, for example. The other ECUs 9 are various ECUs related to traveling control, an ECU related to position management, and the like, for example.

The DCM 1 includes devices such as an antenna, a transceiver, a modulator and a demodulator, and is a device that implements a communication function of the vehicle 10. The DCM 1 communicates with the center server 50 by accessing the network N1 through wireless communication.

The multimedia ECU 2 connects to the microphone 4 and the speaker 5 to control the same, for example. The multimedia ECU 2 includes a car navigation system and an audio system, for example. In the first embodiment, the multimedia ECU 2 receives input of an uttered speech of a driver input via the microphone 4. The multimedia ECU 2 outputs audio related to notification of takeover, inside the vehicle 10 through the speaker 5.

The autonomous driving control ECU 3 performs autonomous driving control of the vehicle 10. Various sensors 6 mounted in the vehicle 10 are connected to the autonomous driving control ECU 3, and signals are input from the various sensors 6. For example, the various sensors 6 include a camera, a Lidar, a Radar, a global navigation satellite system (GNSS) receiver, a GNSS receiving antenna, an accelerometer, a yaw-rate sensor, a rain sensor, and the like. The various sensors 6 may also include a human machine interface (HMI) device. The autonomous driving control ECU 3 is connected to the various sensors 6 directly or via a network inside the vehicle.

The autonomous driving control ECU 3 executes an autonomous driving control algorithm based on input signals from the various sensors 6, and achieves autonomous driving by outputting control signals to actuators for controlling braking, acceleration, a steering wheel, headlights, indicators, a brake lamp and a hazard light and to a drive circuit. In addition to the control signals, the autonomous driving control ECU 3 outputs information to a meter panel and the HMI device such as a display.

In the first embodiment, the autonomous driving control ECU 3 determines, based on the input signals from the various sensors 6, whether autonomous driving will become technically difficult in a driving environment in the near future (such as several seconds later). In the case where it is determined that autonomous driving will become technically difficult, the autonomous driving control ECU 3 generates a takeover request signal for requesting a driver to switch to manual driving, together with a reason therefor. The takeover request signal is input to the multimedia ECU 2.

When the takeover request signal is received, the multimedia ECU 2 outputs, through the speaker 5, audio for notifying the driver of switching to manual driving. Furthermore, in the first embodiment, an explanation about the reason for occurrence of the takeover request is given in a dialogue format. The multimedia ECU 2 downloads, from the center server 50, a correspondence table for utterances of a driver that are expected in a case of demanding an explanation about the reason for occurrence of the takeover request, and an answer including a part of the explanation about the reason for occurrence of the takeover request. Thereafter, the multimedia ECU 2 monitors the utterance of the driver, acquires the answer to the utterance of the driver from the correspondence table, and generates speech data from the acquired answer and outputs the same through the speaker 5.

In the first embodiment, a part of an explanation about the reason for occurrence of a takeover request is presented in response to an utterance of the driver about the occurrence of the takeover request. The correspondence table to be acquired from the center server 50 is prepared step by step in relation to the explanation about the reason for occurrence of the takeover request. Accordingly, in the case where the driver thinks that a presented explanation is not enough, the driver makes an utterance demanding a more detailed explanation, and an explanation is further presented in response. On the other hand, in the case where the driver thinks that the presented explanation is enough, the driver accepts the takeover request. Therefore, according to the first embodiment, a satisfactory explanation about the reason for occurrence of the takeover request may be presented to the driver, and the sense of discomfort felt by the driver may be reduced.

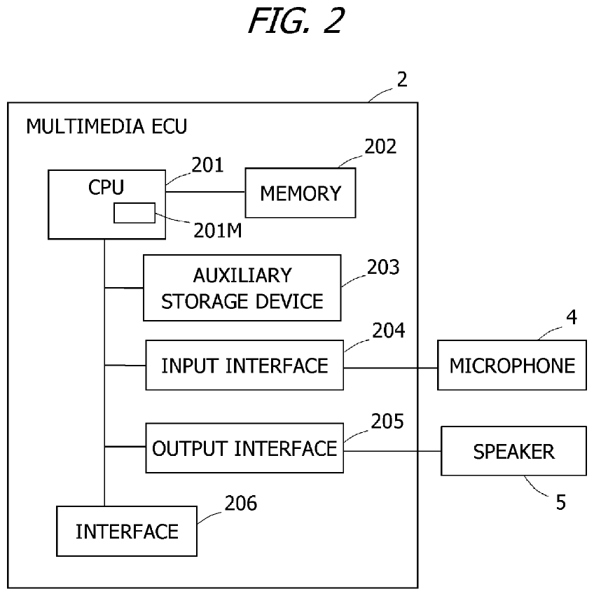

FIG. 2 is an example of a hardware configuration of the multimedia ECU 2. As hardware components, the multimedia ECU 2 includes a CPU 201, a memory 202, an auxiliary storage device 203, an input interface 204, an output interface 205, and an interface 206. The memory 202 and the auxiliary memory 203 are each a computer-readable storage medium.

The auxiliary memory 203 stores various programs, and data to be used by the CPU 201 at the time of execution of each program. For example, the auxiliary memory 203 is an erasable programmable ROM (EPROM) or a flash memory. The programs held in the auxiliary memory 203 include a speech recognition program, an audio signal processing program, a takeover notification control program, and the like. The audio signal processing program is a program for performing digital/analog conversion processes on an audio signal, and for performing a process of conversion between an audio signal and data in a predetermined format. The takeover notification control program is a program for controlling notification of switching to manual driving.

The memory 202 is a main memory that provides a storage area and a work area for loading the programs stored in the auxiliary memory 203, and that is used as a buffer. For example, the memory 202 includes semiconductor memories such as a read only memory (ROM) and a random access memory (RAM).

The CPU 201 performs various processes by loading, in the memory 202, and executing an OS and various other programs held in the auxiliary memory 203. The number of the CPUs 201 is not limited to one and may be more than one. The CPU 201 includes a cache memory 201M.

The input interface 204 is an interface to which the microphone 4 is connected. The output interface 205 is an interface to which the speaker 5 is connected. The interface 206 is a circuit including a port that is used for connection to Ethernet (registered trademark), CAN, or other networks, for example. Note that the hardware configuration of the multimedia ECU 2 is not limited to the one illustrated in FIG. 2.

Like the multimedia ECU 2, the autonomous driving control ECU 3 also includes a CPU, a memory, an auxiliary memory, and an interface. With the autonomous driving control ECU 3, various programs related to autonomous traveling control, and a takeover determination program are stored in the auxiliary memory, for example. Like the multimedia ECU 2, the DCM 1 also includes a CPU, a memory, an auxiliary memory, and an interface. The DCM 1 further includes a wireless communication unit. The wireless communication unit is a wireless communication circuit compatible with a mobile communication method such as 5th Generation (5G), 6G, 4G or long term evolution (LTE), or with a wireless communication method such as WiMAX or WiFi, for example. The wireless communication unit connects to the network N1 through wireless communication to enable communication with the center server 50.

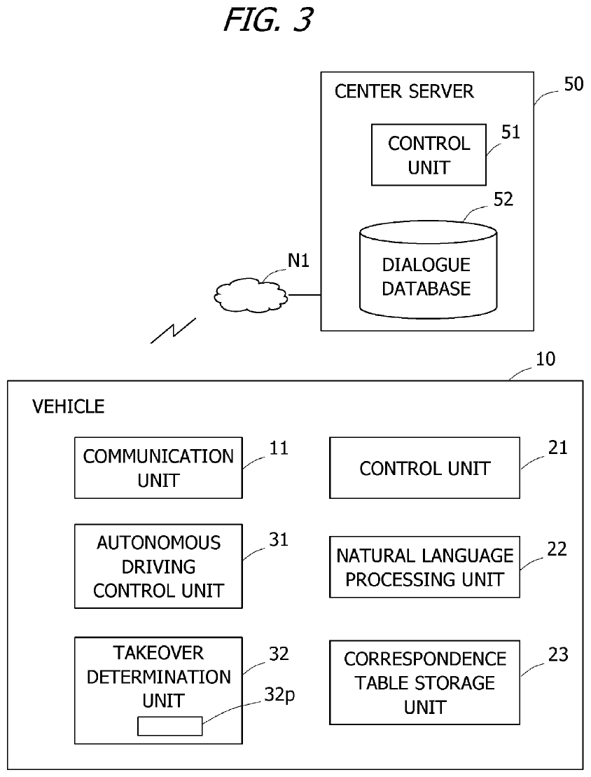

FIG. 3 is a diagram illustrating an example of a functional configuration of the vehicle 10 and the center server 50. As functional components, the vehicle 10 includes a communication unit 11, a control unit 21, a natural language processing unit 22, a correspondence table storage unit 23, an autonomous driving control unit 31, and a takeover determination unit 32. The communication unit 11 is a functional element corresponding to the DCM 1. The communication unit 11 is an interface for communicating with an external server.

The autonomous driving control unit 31 and the takeover determination unit 32 are functional elements corresponding to the autonomous driving control ECU 3. Processes by the autonomous driving control unit 31 and the takeover determination unit 32 are implemented by the CPU of the autonomous driving control ECU 3 executing predetermined programs. The autonomous driving control unit 31 performs autonomous driving control for the vehicle 10. As the autonomous driving control, control of an engine or a motor, brake control, steering control, position management, obstacle detection and the like are performed, for example.

While the vehicle 10 is traveling in the autonomous driving mode, the takeover determination unit 32 determines, every predetermined period of time, whether autonomous driving is capable to be continued, based on detection values from the various sensors 6. For example, to continue autonomous driving of the vehicle 10, a surrounding environment of the vehicle 10 has to be accurately grasped. For example, in the case of poor weather, in the case where a road is poorly maintained, or in the case where a traveling state of vehicles in surrounding are not good, such as in the case of a traffic congestion, the surrounding environment of the vehicle 10 does not come to be accurately grasped by the sensors 6. In such a case, the takeover determination unit 32 determines that it is difficult to continue the autonomous driving. Additionally, conditions for determining, by the takeover determination unit 32, whether autonomous driving may be continued depend on configuration of autonomous driving control of the vehicle 10, and are not limited to specific conditions. Furthermore, a logic for identifying, by the takeover determination unit 32, a cause of occurrence of a takeover request is not limited to a specific method, and may be a method according to a predetermined rule, a logic that uses a machine learning model, or the like.

In the case of determining that it is difficult to continue autonomous driving, the takeover determination unit 32 outputs the takeover request signal to the control unit 21. Furthermore, in the case of determining that it is difficult to continue autonomous driving, the takeover determination unit 32 transmits to the center server 50, through the communication unit 11, a takeover request occurrence notification for notifying of occurrence of a takeover request and an intent number indicating the cause of occurrence of the takeover request. The intent number is acquired by referring to an intent number table 32p described later, for example. The takeover determination unit 32 may output the intent number to the control unit 21, together with the takeover request signal.

The control unit 21, the natural language processing unit 22, and the correspondence table storage unit 23 are functional elements corresponding to the multimedia ECU 2. The control unit 21 controls notification of takeover. The control unit 21 receives input of the takeover request signal and the intent number from the takeover determination unit 32. When input of the takeover request signal is received, the control unit 21 outputs, from the speaker 5, audio urging switching to manual driving. Speech data for urging switching to manual driving is held in the cache memory 201M to reduce a response delay, for example. Output of speech data urging switching to manual driving may be referred to as output of the takeover request.

Furthermore, when input of the takeover request signal is received, the control unit 21 downloads from the center server 50, through the communication unit 11, a correspondence table group for the intent number corresponding to the cause of occurrence of the takeover request, and stores the same in the correspondence table storage unit 23. The correspondence table group is a collection of correspondence tables each associating an utterance of a driver that is expected in a dialogue for explaining the reason for occurrence of a takeover request and an answer to the utterance. The number of correspondence tables that are prepared corresponds to a depth of a dialogue that is expected. The depth of a dialogue indicates the number of sets of utterance and answer for one topic, where an utterance and an answer are taken as one set. Details of the correspondence table will be given later. The correspondence table storage unit 23 corresponds to the cache memory 201M in the multimedia ECU 2.

After outputting audio urging switching to manual driving, the control unit 21 starts a dialogue process for presenting an explanation about the reason for occurrence of the takeover request to the driver in a dialogue format. In the dialogue process, the control unit 21 performs acquisition of an utterance of the driver, acquisition of answer data as an answer to the utterance of the driver, and audio output of the answer data.

The utterance of the driver is acquired by acquiring speech data of the driver by collecting a voice uttered by the driver through the microphone 4, and by the control unit 21 performing a speech recognition process on the speech data of the driver, for example. The utterance of the driver that is acquired as a speech recognition result based on the speech data of the driver may be acquired in the form of text data, for example.

The answer data indicating the answer to the utterance of the driver is acquired by the control unit 21 outputting data of the utterance that is acquired to the natural language processing unit 22, and by receiving input of answer data indicating an answer to the utterance from the natural language processing unit 22, for example.

The answer data for the utterance of the driver may be acquired in the form of text data, for example.

The control unit 21 generates speech data from the answer data for the utterance by speech synthesis, and outputs the same to the speaker 5. The speech data is output as audio by the speaker 5.

The control unit 21 repeatedly performs the dialogue process until the utterance of the driver indicates acceptance of switching to manual driving or until start of manual driving by the driver is detected. The utterance of the driver indicating acceptance of switching to manual driving is “OK” or “I'm driving”, for example. The correspondence table group described later includes correspondence tables for the utterance of the driver that is expected in the case of indicating acceptance of switching to manual driving and the answer to the utterance. For example, the control unit 21 detects that the utterance of the driver indicates acceptance of switching to manual driving, when the utterance of the driver is detected to match or to be similar to an utterance of a driver in the correspondence table.

Together with starting the dialogue process, the control unit 21 monitors motion of the driver by using a sensor that monitors interior of the vehicle 10, for example. The control unit 21 thereby detects start of manual driving by the driver. For example, start of manual driving by the driver is detected by detecting motion such as the driver holding the steering wheel or a line of sight of the driver being directed forward of the vehicle 10. Additionally, the method of detecting start of manual driving by the driver is not limited to a specific method, and any known method may be used.

In the case where takeover is not performed even after a lapse of a predetermined time from start of the dialogue process, the control unit 21 performs a process of requesting the driver to perform takeover, by outputting again the audio urging switching to manual driving, outputting an alarm sound, or tightening a seat belt, for example.

The natural language processing unit 22 performs a search through the correspondence table group stored in the correspondence table storage unit 23 based on the data of the utterance of the driver input from the control unit 21, acquires data as an answer and outputs the same to the control unit 21.

Next, as functional elements, the center server 50 includes a control unit 51 and a dialogue database 52. These functional elements are implemented by a CPU of the center server 50 executing predetermined programs. The control unit 51 receives the takeover request occurrence notification from the vehicle 10. The intent number is also received together with the takeover request occurrence notification. When the takeover request occurrence notification is received, the control unit 51 identifies the correspondence table group for the received intent number, and transmits the same to the vehicle 10. For example, the dialogue database 52 is created in a storage area in an auxiliary storage device of the center server 50. The dialogue database 52 holds a correspondence table group corresponding to each intent number.

Additionally, in the first embodiment, the center server 50 holds the correspondence table group in the dialogue database 52 in advance. However, such a case is not restrictive, and the center server 50 may include a machine learning model instead of the dialogue database 52, and may create the correspondence table group using the machine learning model, for example. Specifically, when the takeover request occurrence notification is received from the vehicle 10, the control unit 51 may create the correspondence table group for the received intent number by using the machine learning model, and may transmit the same to the vehicle 10.

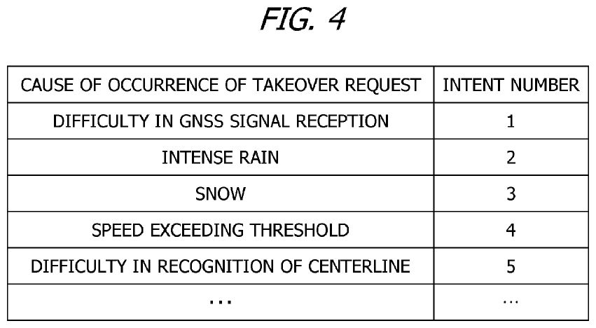

FIG. 4 is an example of the intent number table 32p. The intent number table 32p is held in the auxiliary storage device of the autonomous driving control ECU 3. The intent number table 32p holds assignment of an intent number to the cause of occurrence of a takeover request.

In the example illustrated in FIG. 4, an intent number 1 is assigned to a case where the cause of occurrence of a takeover request is difficulty in reception of a GNSS signal. An intent number 2 is assigned in a case where the cause of occurrence of a takeover request is intense rain. An intent number 3 is assigned in a case where the cause of occurrence of a takeover request is snow. An intent number 4 is assigned in a case where the cause of occurrence of a takeover request is a speed exceeding a threshold. An intent number 5 is assigned in a case where the cause of occurrence of a takeover request is difficulty in recognition of a centerline. Additionally, assignment of the intent numbers illustrated in FIG. 4 is an example, and the intent number may be freely assigned to the cause of occurrence of a takeover request by an administrator of the takeover notification system 100, for example.

<Correspondence Table>

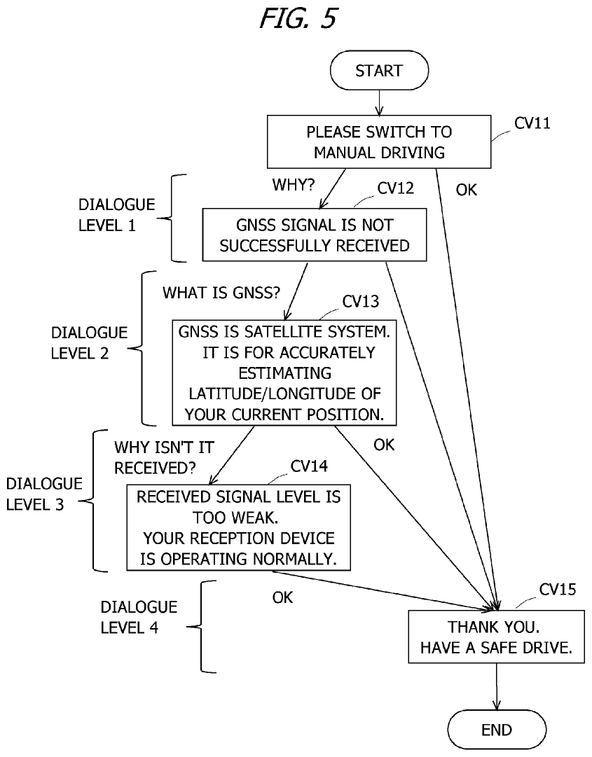

FIG. 5 is a diagram illustrating an example of a dialogue scenario that arises in relation to explanation of the reason for occurrence of a takeover request. In the example illustrated in FIG. 5, a dialogue scenario for a case where the reason for occurrence of a takeover request is difficulty in reception of a GNSS signal will be described.

When a takeover request occurs, first, audio CV101 of a message “please switch to manual driving” urging switching to manual driving is presented. In the case where the driver wants to know the reason for occurrence of the takeover request, an utterance asking for the reason for occurrence of the takeover request is expected. In the example illustrated in FIG. 5, “why?” is given as an example of an utterance asking for the reason for occurrence of the takeover request. As an answer to the utterance asking for the reason for occurrence of the takeover request, audio CV102 “GNSS signal is not successfully received” stating the cause of occurrence of the takeover request is output. In the first embodiment, an utterance and an answer to the utterance is taken as one set of dialogue. Furthermore, depth of the dialogue is increased every one set of dialogue. In the following, the depth of the dialogue will be referred to as a dialogue level. In the example illustrated in FIG. 5, the utterance “why?” of the driver and the audio CV102 as the answer are at a dialogue level 1.

In the case where the driver demands further explanation in response to the audio CV102 “GNSS signal is not successfully received” stating the cause of occurrence of the takeover request, an utterance asking about the GNSS signal, and an utterance asking for the cause of failure to receive the GNSS signal are expected to further arise, for example.

In the example illustrated in FIG. 5, an utterance asking about the GNSS signal is expected to be made by the driver after the audio CV102 stating the cause of occurrence of the takeover request. In the example illustrated in FIG. 5, “what is GNSS?” is indicated as the utterance asking about the GNSS signal. In response, audio CV103 explaining the GNSS is output as an answer to the utterance asking about the GNSS signal. In the example illustrated in FIG. 5, the dialogue level is increased by one, to a dialogue level 2, by the set of the utterance asking about the GNSS signal and the audio CV103 as the answer.

In the example illustrated in FIG. 5, an utterance asking for the cause of failure to receive the GNSS signal is expected to be made by the driver after the audio CV103 explaining the GNSS. In the example illustrated in FIG. 5, “why isn't it received?” is indicated as the utterance asking for the cause of failure to receive the GNSS signal. In response, audio CV104 explaining the cause of failure to receive the GNSS signal is output as the answer to the utterance asking for the cause of failure to receive the GNSS signal. In the example illustrated in FIG. 5, the dialogue level is further increased by one, to a dialogue level 3, by the set of the utterance asking for the cause of failure to receive the GNSS signal and the audio CV104 as the answer.

In the example illustrated in FIG. 5, an utterance indicating that the driver accepts switching to manual driving is expected to be made after the audio CV104 explaining the cause of failure to receive the GNSS signal. In the example illustrated in FIG. 5, “OK” is indicated as the utterance indicating acceptance of switching to manual driving. In response, audio CV105 acknowledging acceptance of switching to manual driving is output. In the example illustrated in FIG. 5, the dialogue level is further increased by one, to a dialogue level 4, by the utterance indicating acceptance of switching to manual driving and the audio CV105 as the answer.

In the example of the dialogue scenario illustrated in FIG. 5, the dialogue levels 1 to 4 are present, and a correspondence table for each dialogue level is prepared. However, the dialogue is not necessarily carried out in the different order from that illustrated in FIG. 5. In the dialogue scenario illustrated in FIG. 5, a case is also assumed where the utterance “OK” indicating acceptance of switching to manual driving is made after output of the audio CV101 urging switching to manual driving, the audio CV102 as the answer at the dialogue level 1, and the audio CV103 as the answer at the dialogue level 2. In the case where the utterance “OK” indicating acceptance of switching to manual driving is made, the audio CV105 as the answer at the dialogue level 4 is output.

Furthermore, a case is also conceivable where the utterance “why isn't it received?” asking for the cause of failure to receive the GNSS signal is made after output of the audio CV102 as the answer at the dialogue level 1, for example. In this case, the audio CV103 as the answer at the dialogue level 3 is output.

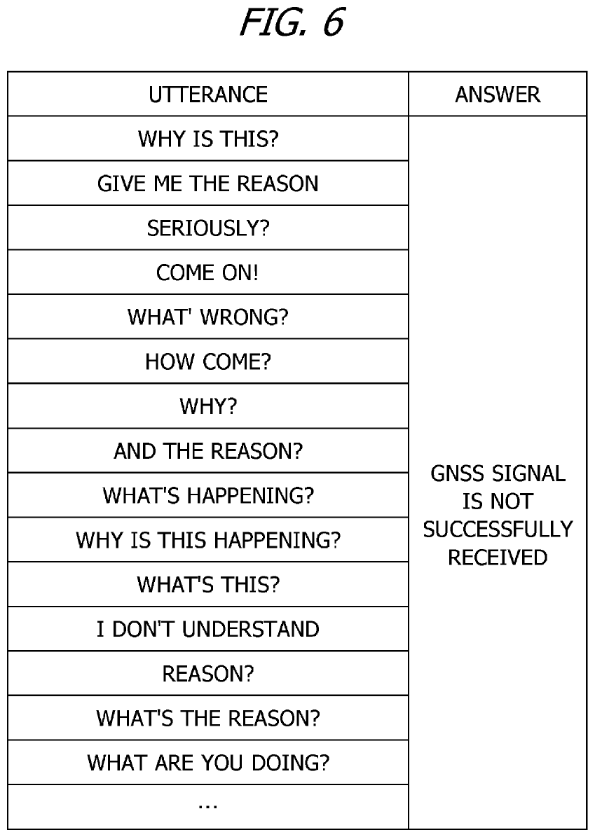

FIGS. 6 to 9 are each an example of a correspondence table included in the correspondence table group corresponding to the dialogue scenario illustrated in FIG. 5, where the cause of occurrence of the takeover request is difficulty in reception of the GNSS signal. FIG. 6 is an example of the correspondence table for the dialogue level 1 for the case where the cause of occurrence of the takeover request is difficulty in reception of the GNSS signal. In the case where the driver asks for the reason for occurrence of the takeover request after output of the audio urging switching to manual driving, it is conceivable that the driver first asks for the cause of occurrence of the takeover request. Accordingly, in the first embodiment, regardless of the cause of occurrence of the takeover request, the answer in the correspondence table for the dialogue level 1 indicates the cause of occurrence of the takeover request.

In the example illustrated in FIG. 6, utterances of the driver that are expected in the case of asking for the cause of occurrence of a takeover request are associated with a message, as the answer, indicating that the cause of occurrence of the takeover request is difficulty in reception of the GNSS signal. In the example illustrated in FIG. 6, “why is this?”, “give me the reason”, “seriously?” and the like are set as the utterances of the driver that are expected in the case of asking for the cause of occurrence of the takeover request, for example. In the example illustrated in FIG. 6, “GNSS signal is not successfully received” is set as the message indicating that the cause of occurrence of the takeover request is difficulty in reception of the GNSS signal.

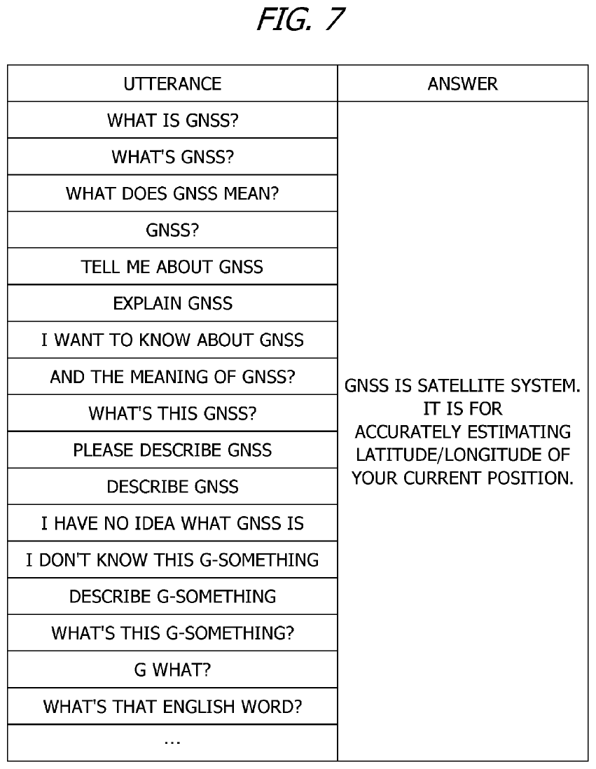

FIG. 7 is an example of the correspondence table for the dialogue level 2 for the case where the cause of occurrence of the takeover request is difficulty in reception of the GNSS signal. The correspondence table for the dialogue level 2 or later associates questions that further arise from the answer at the dialogue level 1 and the answer to the questions.

In the correspondence table for the dialogue level 2 illustrated in FIG. 7, utterances of the driver that are expected in the case of asking about the GNSS signal are associated with a message, as the answer, explaining the GNSS signal. In the example illustrated in FIG. 7, “what is GNSS?”, “what's GNSS?”, “what does GNSS mean?” and the like are set as the utterances of the driver that are expected in the case of asking about the GNSS signal, for example. In the example illustrated in FIG. 7, “GNSS is satellite system. It is for accurately estimating latitude/longitude of your current position” is set as the message explaining the GNSS signal.

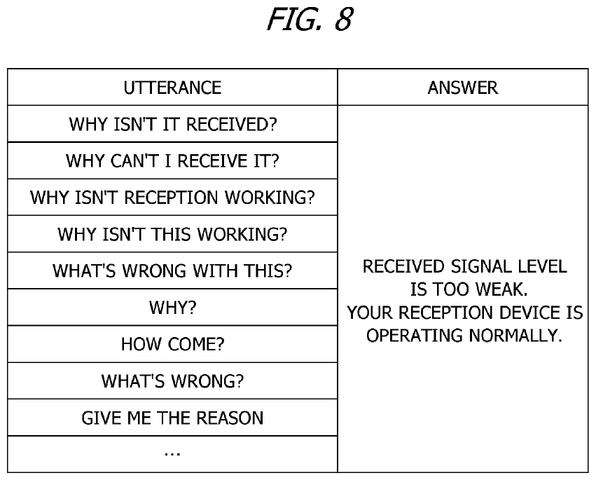

FIG. 8 is an example of the correspondence table for the dialogue level 3 for the case where the cause of occurrence of the takeover request is difficulty in reception of the GNSS signal. In the correspondence table for the dialogue level 3 illustrated in FIG. 8, utterances of the driver that are expected in the case of asking for the cause of failure to receive the GNSS signal are associated with a message, as the answer, explaining the cause of failure to receive the GNSS signal. In the example illustrated in FIG. 8, “why isn't it received?”, “why can't I receive it?”, “why isn't reception working?” and the like are set as the utterances of the driver that are expected in the case of asking for the cause of failure to receive the GNSS signal, for example. In the example illustrated in FIG. 8, “received signal level is too weak. Your reception device is operating normally” is set as the message explaining the cause of failure to receive the GNSS signal.

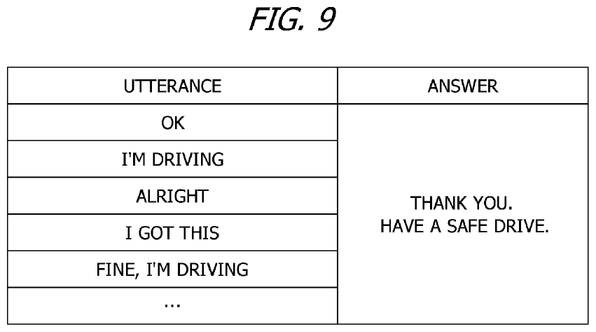

FIG. 9 is an example of the correspondence table for the dialogue level 4 for the case where the cause of occurrence of the takeover request is difficulty in reception of the GNSS signal. In the correspondence table for the dialogue level 4 illustrated in FIG. 9, utterances of the driver that are expected in the case of accepting switching to manual driving are associated with a message, as the answer, acknowledging acceptance of switching to manual driving. In the example illustrated in FIG. 9, “OK”, “I'm driving”, “alright” and the like are set as the utterances of the driver that are expected in the case of accepting switching to manual driving, for example. In the example illustrated in FIG. 9, “thank you. Have a safe drive” is set as the message acknowledging acceptance of switching to manual driving. In the case where the cause of occurrence of the takeover request is difficulty in reception of the GNSS signal, control unit 21 determines end of the dialogue process when the utterance of the driver matches or is similar to an utterance included in the correspondence table for the dialogue level 4 and the answer included in the correspondence table for the dialogue level 4 is given.

For example, in the case where the cause of occurrence of a takeover request is difficulty in reception of the GNSS signal, and the correspondence table group includes the correspondence tables in FIGS. 6 to 9, the answer to an utterance of the driver is acquired in the dialogue process in the following manner. After the dialogue process is started, when a first utterance of the driver is input, the natural language processing unit 22 at least searches through the correspondence tables for the dialogue levels 1 and 4. Additionally, in the case where an answer is acquired in relation to the utterance of the driver that is input, this is counted as one dialogue. In the case where an answer is not acquired in relation to the utterance of the driver that is input, this results in an error and is not counted as one dialogue.

At a second or later input of the utterance of the driver, the natural language processing unit 22 may exclude the correspondence table including the answer that is used once and refer to the remaining correspondence tables, and may acquire the answer to the utterance of the driver that is input. For example, in the case where the first utterance of the driver matches an utterance included in the correspondence table for the dialogue level 1 and is answered with the answer included in the correspondence table for the dialogue level 1, the correspondence tables for the dialogue levels 2 to 4 are referred to at the time of second input of the utterance of the driver. When an answer is given using the answer in the correspondence table for the dialogue level 4, the dialogue process is ended.

Additionally, the utterances of the driver in each correspondence table may be acquired from actual past data, or may be set by the administrator of the takeover notification system 100, for example. Furthermore, an actual utterance of the driver does not necessarily completely match an utterance included in a correspondence table. Accordingly, in the first embodiment, also in the case where the actual utterance of the driver is similar to an utterance included in a correspondence table, as in the case where the actual utterance completely matches an utterance included in the correspondence table, the natural language processing unit 22 acquires the answer included in the correspondence table as the answer to the actual utterance of the driver.

Additionally, the correspondence tables included in the correspondence table group for the case where the cause of occurrence of the takeover request is difficulty in reception of the GNSS signal are set as appropriate according to an embodiment without being limited to the four tables for the dialogue levels 1 to 4. Furthermore, the correspondence tables for the dialogue levels in the case where the cause of occurrence of the takeover request is difficulty in reception of the GNSS signal are not limited to the correspondence tables illustrated in FIGS. 6 to 9.

The correspondence table group is prepared in the dialogue database 52 in the center server 50, for each cause of occurrence of the takeover request. A maximum value of the dialogue level is different for each cause of occurrence of the takeover request. However, with any cause of occurrence of the takeover request, the correspondence table for the dialogue level 1 is association between the utterances of the driver that are expected in the case of asking for the cause of occurrence of the takeover request and a message, as the answer, indicating the cause of occurrence of the takeover request. Furthermore, with any cause of occurrence of the takeover request, the correspondence table for the dialogue level with the maximum value is association between the utterances of the driver that are expected in the case of acceptance of manual driving and a message, as the answer, acknowledging acceptance of manual driving. The answer included in each correspondence table corresponds to “a part of an explanation about a reason for occurrence of a request to switch to manual driving”.

<Flow of Processes>

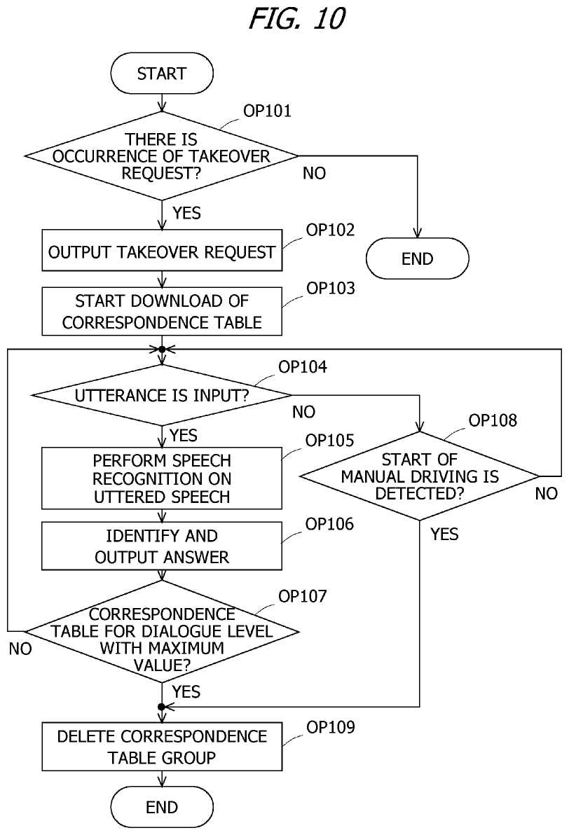

FIG. 10 is an example of a flowchart of a takeover notification process by the vehicle 10 according to the first embodiment. The process illustrated in FIG. 10 is repeated every predetermined period of time while the vehicle 10 is traveling in the autonomous driving mode. A main performer of the process illustrated in FIG. 10 is the autonomous driving control ECU 3, but a description will be given taking a functional element as the main performer for the sake of convenience.

In OP101, the control unit 21 determines whether there is occurrence of the takeover request. The control unit 21 detects occurrence of the takeover request in a case where the takeover request signal is input from the takeover determination unit 32. In the case where there is occurrence of the takeover request (OP101: YES), the process proceeds to OP102. In the case where there is no occurrence of the takeover request (OP101: NO), the process illustrated in FIG. 10 is ended.

In OP102, the control unit 21 outputs the takeover request. To output the takeover request is to output a message urging switching to manual driving. In OP103, the control unit 21 starts downloading, from the center server 50, the correspondence table group for the intent number corresponding to the cause of occurrence of the takeover request. The downloaded correspondence tables are stored in the correspondence table storage unit 23.

Processes from OP104 to OP108 are processes corresponding to the dialogue process. In OP104, the control unit 21 determines whether an uttered speech of the driver is input through the microphone 4. In the case where an uttered speech of the driver is input through the microphone 4 (OP104: YES), the process proceeds to OP105. In the case where an uttered speech of the driver is not input (OP104: NO), the process proceeds to OP108.

In OP105, the control unit 21 performs speech recognition on uttered speech data that is input and acquires the utterance. In OP106, the control unit 21 outputs the utterance of the driver to the natural language processing unit 22, and acquires answer data for the utterance of the driver from the natural language processing unit 22. The control unit 21 generates speech data from the answer data by speech synthesis, and causes audio corresponding to the speech data to be output from the speaker 5. The natural language processing unit 22 performs, based on the utterance of the driver, a search through the correspondence tables stored in the correspondence table storage unit 23, and outputs, to the control unit 21, the answer data included in the correspondence table including an utterance to which the utterance of the driver matches or is similar.

In OP107, the control unit 21 determines whether the answer output in OP106 is acquired from the correspondence table for the dialogue level with the maximum value in the correspondence table group for the intent number corresponding to the cause of occurrence of the takeover request. In the case where the answer output in OP106 is acquired from the correspondence table for the dialogue level with the maximum value in the correspondence table group for the intent number corresponding to the cause of occurrence of the takeover request (OP107: YES), the dialogue process is ended, and the process proceeds to OP109.

In the case where the answer output in OP106 is acquired from a correspondence table other than the correspondence table for the dialogue level with the maximum value in the correspondence table group for the intent number corresponding to the cause of occurrence of the takeover request (OP107: NO), the process proceeds to

OP104.

In OP108, the control unit 21 determines whether manual driving is started by the driver. That manual driving by the driver is started is determined by detecting the driver holding the steering wheel, from a captured image from a camera capturing an interior of the vehicle 10, or by detecting that a line of sight of the driver is directed forward of the vehicle 10, for example. In the case where the driver is detected to have started manual driving (OP108: YES), the dialogue process is ended, and the process proceeds to OP109. In the case where the driver is not detected to have started manual driving (OP108: NO), the process proceeds to OP104.

In OP109, the control unit 21 deletes the correspondence table group that is stored in the correspondence table storage unit 23. Then, the process illustrated in FIG. 10 is ended. Additionally, the process by the vehicle 10 is not limited to the process illustrated in FIG. 10. For example, in FIG. 10, the dialogue process is performed until acceptance of switching to manual driving is indicated by the utterance of the driver (OP107) or start of manual driving is detected (OP108).

However, such a case is not restrictive, and one of acceptance of switching to manual driving based on the utterance of the driver and start of manual driving may be taken as a condition for ending the dialogue process.

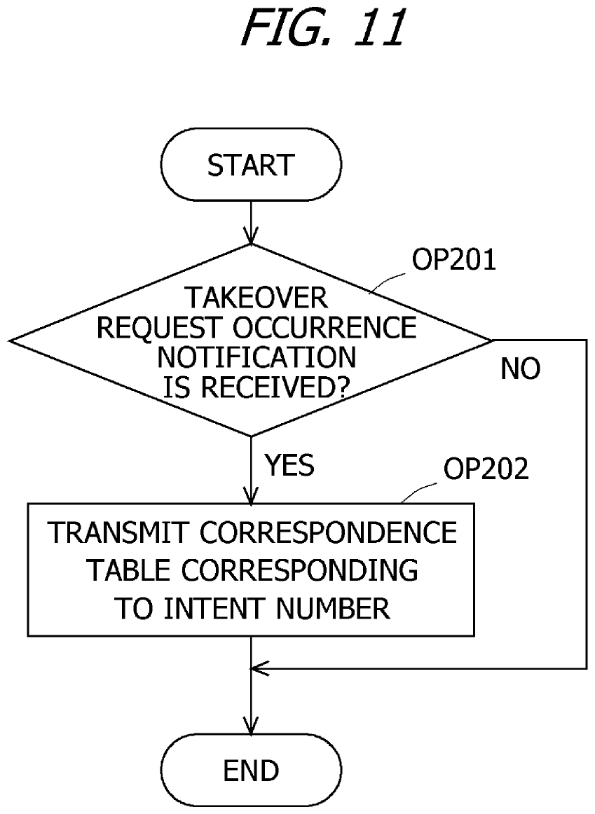

FIG. 11 is an example of a flowchart of a takeover notification process by the center server 50 according to the first embodiment. The process illustrated in FIG. 11 is repeated every predetermined period of time. A main performer of the process illustrated in FIG. 11 is the CPU of the center server 50, but a description will be given taking a functional element as the main performer for the sake of convenience.

In OP201, the control unit 51 determines whether the takeover request occurrence notification is received from the vehicle 10. The intent number is also received together with the takeover request occurrence notification. In the case where the takeover request occurrence notification is received from the vehicle 10 (OP201: YES), the process proceeds to OP202. In the case where the takeover request occurrence notification is not received from the vehicle 10 (OP201: NO), the process illustrated in FIG. 11 is ended.

In OP202, the control unit 51 reads out, from the dialogue database 52, the correspondence table group for the intent number that is received from the vehicle 10, and transmits the same to the vehicle 10. Then, the process illustrated in FIG. 11 is ended.

<Download of Correspondence Table>

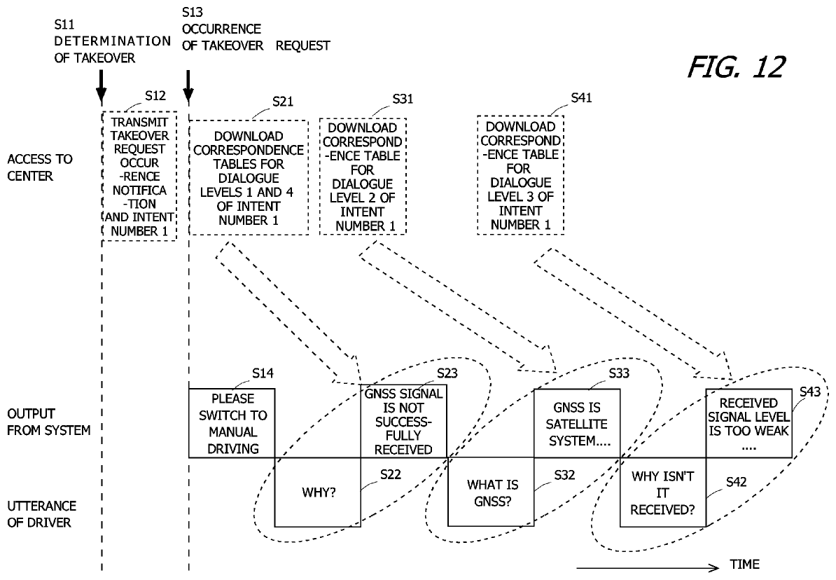

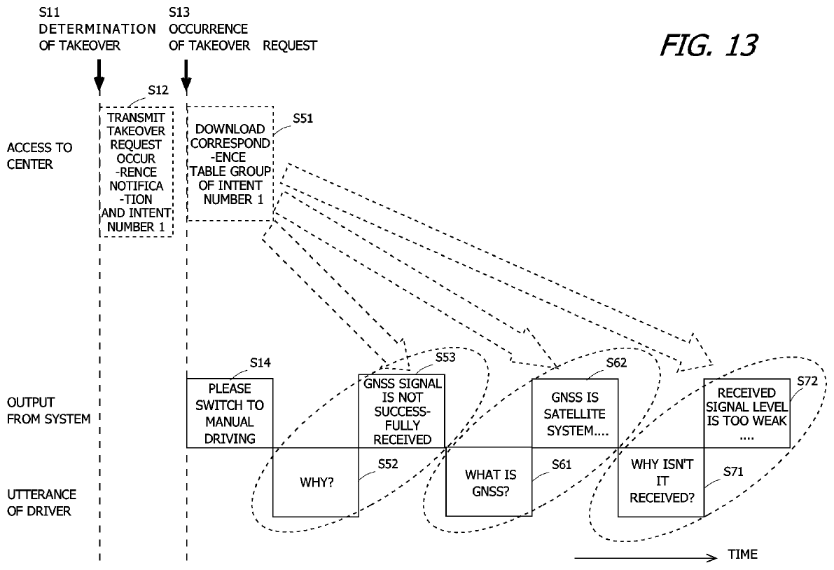

FIGS. 12 and 13 are each an example of a time chart related to download of the correspondence table group and the dialogue process. FIGS. 12 and 13 are each an example of a case where the cause of occurrence of the takeover request is difficulty in reception of the GNSS signal, and where the correspondence tables for the dialogue levels 1 to 4 illustrated in FIGS. 6 to 9 are downloaded from the center server 50.

In the example illustrated in FIG. 12, download of the correspondence table group from the center server 50 is performed on a per-correspondence table basis. In S11, it is determined that continuing autonomous driving is difficult for the vehicle 10 (determination of takeover). In S12, the takeover request occurrence notification and the intent number 1 indicating that the cause of occurrence of the takeover request is difficulty in reception of the GNSS signal (for example, see FIG. 4) are transmitted from the vehicle 10 to the center server 50. In S13, the takeover request signal is output in the vehicle 10, from the autonomous driving control ECU 3 to the multimedia ECU 2 (FIG. 10, OP 101). In S14, audio of a message urging switching to manual driving (FIG. 12, “please switch to manual driving”) is output in the vehicle 10 (FIG. 10, OP102).

In S21, the vehicle 10 downloads the correspondence tables for the dialogue levels 1 and 4 corresponding to the intent number 1 from the center server 50 while the audio of the message urging switching to manual driving is being output. The correspondence table for the dialogue level 4 is the correspondence table for the dialogue level with the maximum value in the correspondence table group for the intent number 1. In S22, the driver makes an utterance asking for the cause of occurrence of the takeover request (in FIG. 12, “why?). Because download of the correspondence tables for the dialogue levels 1 and 4 is already completed at a time point of S22, the vehicle 10 outputs, in S23, the answer included in the correspondence table for the dialogue level 1 in the form of audio (see FIG. 6; in FIG. 12, “GNSS signal is not successfully received”).

In S31, while an utterance of the driver is being waited for or is being subjected to speech recognition after output of audio of the message urging switching to manual driving, the vehicle 10 downloads the correspondence table for the dialogue level 2 corresponding to the intent number 1 from the center server 50. In S32, an utterance asking about the GNSS signal (in FIG. 12, “what is GNSS?”) is made by the driver. Because download of the correspondence table for the dialogue level 2 is already completed at a time point of S32, the vehicle 10 outputs, in S33, the answer included in the correspondence table for the dialogue level 2 in the form of audio (see FIG. 7; in FIG. 12, “GNSS is satellite system. . . .”).

In S41, the vehicle 10 downloads the correspondence table for the dialogue level 3 corresponding to the intent number 1 from the center server 50 while the answer included in the correspondence table for the dialogue level 1 is being output in S23 in the form of audio. In S42, an utterance asking for the cause of failure to receive the GNSS signal (in FIG. 12, “why isn't it received?”) is made by the driver. Because download of the correspondence table for the dialogue level 3 is already completed at a time point of S42, the vehicle 10 outputs, in S43, the answer included in the correspondence table for the dialogue level 3 in the form of audio (see FIG. 8; in FIG. 12, “received signal level is too weak. . . .”). From then on, the correspondence table group for the intent number 1 is held by the vehicle 10, and the same process is repeated until the answer included in the correspondence table for the dialogue level 4 is output as the answer or start of manual driving is detected.

In the example illustrated in FIG. 12, a delay time in answering the utterance of the driver may be reduced by downloading in advance the correspondence table for an utterance that is highly likely to be made next.

In the example illustrated in FIG. 13, download of the correspondence table group from the center server 50 is performed by collectively downloading all the correspondence tables included in the correspondence table group corresponding to the cause of occurrence of the takeover request. S11 to S14 are the same as those in FIG. 12. In S51 in FIG. 13, the vehicle 10 collectively downloads all the correspondence tables included in the correspondence table group for the intent number 1 from the center server 50 while audio of the message urging switching to manual driving is being output.

Thereafter, because all the corresponding tables in the correspondence table group for the intent number 1 are held by the vehicle 10, when questions are uttered in S52, S61 and S71, answers may be given as indicated by S53, S62 and S72 with a shorter delay time. Additionally, utterances of the driver in S52, S61 and S71 are the same as those in S22, S32 and S42 in FIG. 12. The answers in S53, S62 and S72 to the utterances of the driver are the same as those in S23, S33 and S43 in FIG. 12. By collectively downloading the correspondence table group, influence of network delay may be reduced, and an utterance of the driver may be more swiftly responded.

Whether to download the correspondence table group corresponding to the cause of occurrence of the takeover request on a per-correspondence table basis or in a collective manner may be freely set by the administrator of the takeover notification system 100, for example.

<Effects of First Embodiment>

In the first embodiment, in the case of occurrence of the takeover request, a part of an explanation about the reason for occurrence of the takeover request is presented to the driver according to the utterance of the driver. Accordingly, a satisfactory explanation may be presented according to the level of interest, of the driver, in the reason for occurrence of the takeover request, and the sense of discomfort that is felt may be reduced.

Furthermore, in the first embodiment, the vehicle 10 downloads, from the center server 50, the correspondence table group corresponding to the cause of occurrence of the takeover request before the driver makes an utterance, and holds the correspondence table group in the cache memory 201M. Accordingly, it may more swiftly responds to an utterance of the driver.

### Second Embodiment

In the first embodiment, the vehicle 10 acquires answer data as the answer to an utterance of the driver. Accordingly, in the first embodiment, the vehicle 10 downloads, from the center server 50, the correspondence table group corresponding to the cause of occurrence of the takeover request before the driver makes an utterance, and holds the correspondence table group in the cache memory 201M.

Instead, in a second embodiment, acquisition of the answer data as the answer to an utterance of the driver is performed by the center server. Accordingly, in the second embodiment, the vehicle does not download, from the center server, the correspondence table group corresponding to the cause of occurrence of the takeover request. Additionally, in the second embodiment, description of common explanations with the first embodiment will be omitted.

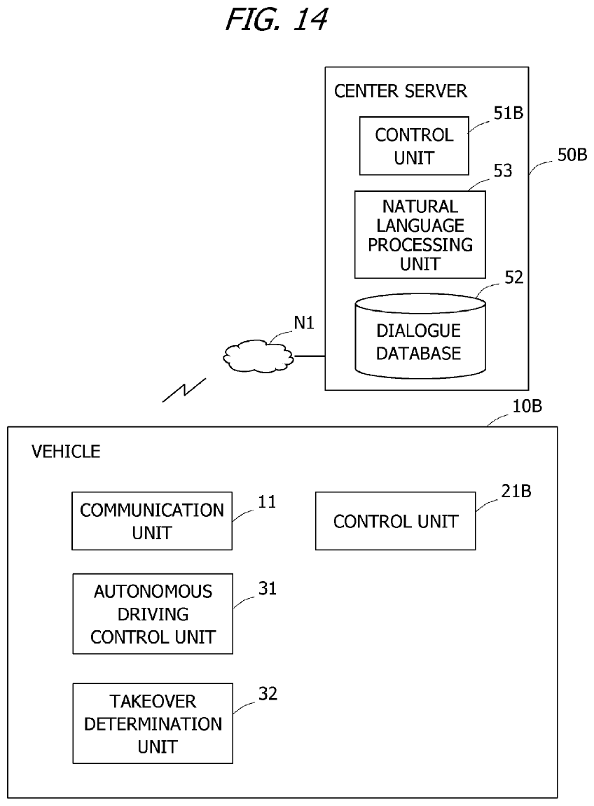

FIG. 14 is a diagram illustrating an example of a functional configuration of a vehicle 10B and a center server 50B according to the second embodiment. In the second embodiment, the system configuration of the takeover notification system 100 and hardware configurations of the vehicle 10B and the center server 50B are the same as those in the first embodiment. In the second embodiment, the vehicle 10B includes, as functional components, the communication unit 11, a control unit 21B, the autonomous driving control unit 31, and the takeover determination unit 32. The communication unit 11, the autonomous driving control unit 31, and the takeover determination unit 32 are the same as those in the first embodiment.

The control unit 21B is a functional element corresponding to the multimedia ECU 2. When the takeover request signal is input, the control unit 21B starts monitoring of audio that is input through the microphone 4 after outputting audio urging switching to manual driving from the speaker 5. When an uttered speech of the driver is input from the microphone 4, the control unit 21B performs a speech recognition process on uttered speech data, and acquires the utterance of the driver. The control unit 21B transmits data of the utterance of the driver to the center server 50B through the communication unit 11. Then, when the answer data is received from the center server 50B through the communication unit 11, the control unit 21B generates speech data by speech synthesis from the answer data for the utterance of the driver, and outputs the speech data to the speaker 5. The speech data is output in the form of audio by the speaker 5. Data of the utterance of the driver that is transmitted to the center server 50B is in the form of text data, for example.

Furthermore, when the takeover request signal is input, the control unit 21B starts monitoring motion of the driver by using a sensor for monitoring the interior of the vehicle 10B, for example. When detecting that manual driving by the driver is started, the control unit 21B transmits, to the center server 50B, a manual driving start notification indicating that manual driving by the driver is started. The control unit 21B performs the process of acquiring the utterance of the driver and monitoring of the motion of the driver until a dialogue end notification is received from the center server 50B. In other respects, the processes by the control unit 21B are the same as those of the control unit 21 in the first embodiment.

Furthermore, in the second embodiment, the center server 50B includes, as functional components, a control unit 51B, the dialogue database 52, and a natural language processing unit 53. When data of the utterance of the driver is received from the vehicle 10B, the control unit 51B outputs the same to the natural language processing unit 53, and acquires the answer data for the utterance of the driver from the natural language processing unit 53. The control unit 51B transmits the acquired answer data to the vehicle 10B. The answer data may be text data, or may be speech data in a predetermined format, for example.

The natural language processing unit 53 performs a search through the correspondence table group, for the intent number, stored in the natural language processing unit 53, in relation to the data of the utterance of the driver input from the control unit 51B, acquires data as the answer and outputs the same to the control unit 51B. Additionally, the correspondence table group is the same as the one in the first embodiment.

In the case where the utterance of the driver indicates acceptance of switching to manual driving, or in other words, in the case where the answer to the utterance of the driver is acquired from the correspondence table for the dialogue level with the maximum value in the correspondence dialogue table, and in the case where the manual driving start notification is received from the vehicle 10B, the control unit 51B transmits the dialogue end notification to the vehicle 10B.

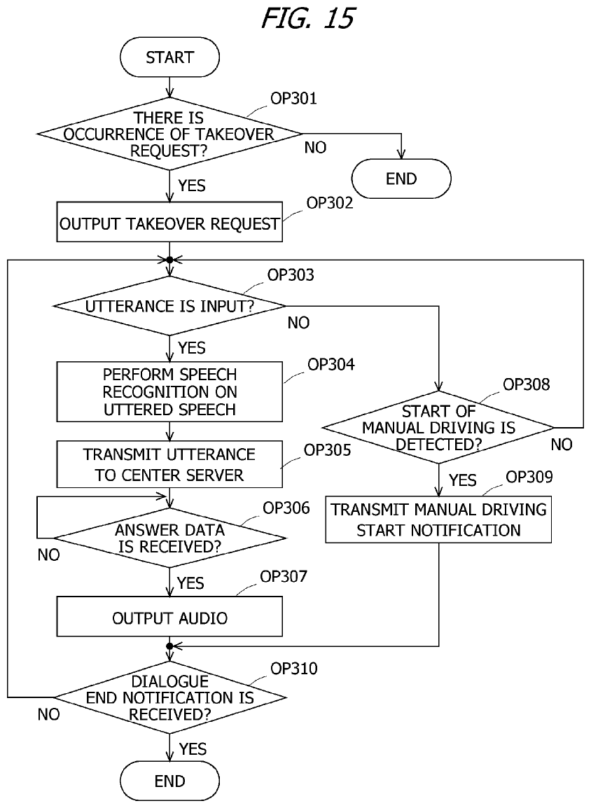

FIG. 15 is an example of a flowchart of the takeover notification process by the vehicle 10B according to the second embodiment. The process illustrated in FIG. 15 is repeated every predetermined period of time while the vehicle 10B is traveling in the autonomous driving mode.

In OP301, the control unit 21B determines whether there is occurrence of the takeover request. In the case where there is occurrence of the takeover request (OP301: YES), the process proceeds to OP302. In the case where there is no occurrence of the takeover request (OP301: NO), the process illustrated in FIG. 15 is ended.

In OP302, the control unit 21B outputs the takeover request. In OP303, the control unit 21B determines whether an uttered speech of the driver is input through the microphone 4. In the case where an uttered speech of the driver is input through the microphone 4 (OP303: YES), the process proceeds to OP304. In the case where an uttered speech of the driver is not input (OP303: NO), the process proceeds to OP308.

In OP304, the control unit 21B performs speech recognition on uttered speech data that is input and acquires data of the utterance. In OP305, the control unit 21B transmits the data of the utterance to the center server 50B. In OP306, the control unit 21B determines whether the answer data is received from the center server 50B. In the case where the answer data is received from the center server 50B (OP306: YES), the process proceeds to OP307. A wait state continues until the answer data is received from the center server 50B (OP306: NO), and an error is obtained in a case where the answer data is not received even after a predetermined period of time.

In OP307, the control unit 21B generates speech data from the answer data by speech synthesis, and outputs audio corresponding to the speech data from the speaker 5.

In OP308, the control unit 21B determines whether manual driving is started by the driver. In the case where the driver is detected to have started manual driving (OP308: YES), the process proceeds to OP309. In OP309, the control unit 21B transmits the manual driving start notification to the center server 50B. In the case where the driver is not detected to have started manual driving (OP308: NO), the process proceeds to OP303.

In OP310, the control unit 21B determines whether the dialogue end notification is received from the center server 50B. In the case where the dialogue end notification is received from the center server 50B (OP310: YES), the process illustrated in FIG. 15 is ended. In the case where the dialogue end notification is not received from the center server 50B (OP310: NO), the process proceeds to OP303.

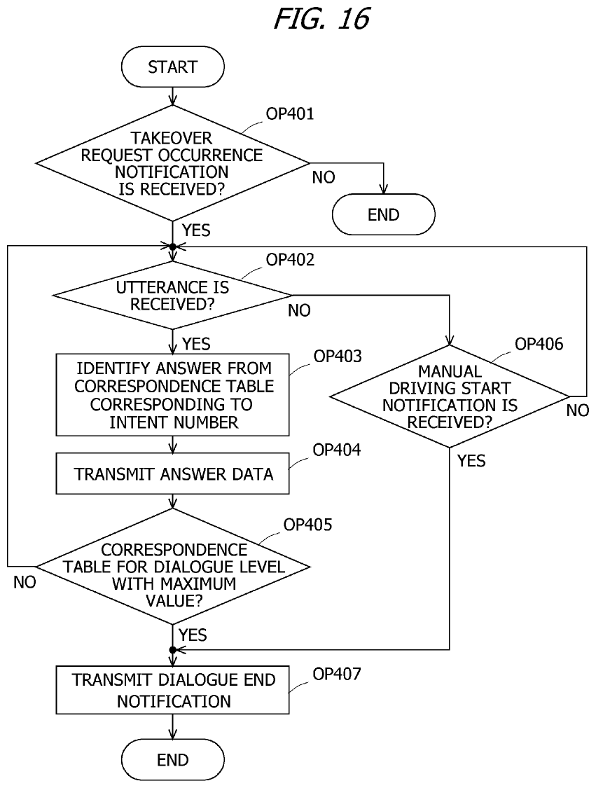

FIG. 16 is an example of a flowchart of the takeover notification process by the center server 50B according to the second embodiment. The process illustrated in FIG. 16 is repeated every predetermined period of time. A main performer of the process illustrated in FIG. 16 is a CPU of the center server 50B, but a description will be given taking a functional element as the main performer for the sake of convenience.

In OP401, the control unit 51B determines whether the takeover request occurrence notification is received from the vehicle 10B. The intent number is also received together with the takeover request occurrence notification. In the case where the takeover request occurrence notification is received from the vehicle 10B (OP401: YES), the process proceeds to OP402. In the cases where the takeover request occurrence notification is not received from the vehicle 10B (OP401: NO), the process illustrated in FIG. 16 is ended.

In OP402, the control unit 51B determines whether data of the utterance of the driver is received from the vehicle 10B. In the case where data of the utterance of the driver is received from the vehicle 10B (OP402: YES), the process proceeds to OP403. In the case where data of the utterance of the driver is not received from the vehicle 10B (OP402: NO), the process proceeds to OP406.

In OP403, the control unit 51B outputs data of the utterance of the driver to the natural language processing unit 53, and acquires answer data for the utterance of the driver, from the natural language processing unit 53. The natural language processing unit 53 performs, based on the utterance of the driver, a search through the correspondence table group, stored in the natural language processing unit 53, corresponding to the intent number that is received, and outputs, to the control unit 51B, the answer data included in the correspondence table including an utterance to which the utterance of the driver matches or is similar. In OP404, the control unit 51B transmits the answer data to the vehicle 10B.

In OP405, the control unit 51B determines whether the answer in the answer data acquired in OP403 is acquired from the correspondence table for the dialogue level with the maximum value in the correspondence table group for the intent number that is received. In the case where the answer in the answer data is acquired from the correspondence table for the dialogue level with the maximum value in the correspondence table group for the intent number that is received (OP405: YES), the process proceeds to OP407. In the case where the answer in the answer data is acquired from a correspondence table, in the correspondence table group for the intent number that is received, other than the correspondence table for the dialogue level with the maximum value (OP405: NO), the process proceeds to OP402.

In OP407, the control unit 51B transmits the dialogue end notification to the vehicle 10B. The process illustrated in FIG. 16 is then ended. Additionally, the processes illustrated in FIGS. 15 and 16 are merely examples, and the processes by the vehicle 10B and the center server 50B according to the second embodiment are not limited to those described above.

In the second embodiment, when the driver makes an utterance, the vehicle 10B transmits the utterance of the driver to the center server 50B, and acquires the answer data for the utterance of the driver from the center server 50B. Accordingly, because the vehicle 10B does not have to download the correspondence table group from the center server 50B and store the same in the cache memory 201B, resources in the cache memory 201M may be saved.

### OTHER EMBODIMENTS

The embodiments described above are examples, and the present disclosure may be changed and carried out as appropriate without departing from the gist of the present disclosure.

In the first and second embodiments, the multimedia ECU 2 performs the dialogue process and the like, but instead, the dialogue process may be performed by the DCM 1 or an on-board unit such as a car navigation system, for example. In this case, the on-board unit is an example of “information processing apparatus”.

In the first and second embodiments, the explanation about the reason for occurrence of the takeover request is presented to the driver in the form of audio from the speaker 5, but such a case is not restrictive. For example, the explanation about the reason for occurrence of the takeover request may be presented to the driver in the form of text on a display in the vehicle 10. The method of presenting the explanation about the reason for occurrence of the takeover request is not limited to a predetermined method.

The processes and means described in the present disclosure may be freely combined to the extent that no technical conflict exists.

A process which is described to be performed by one device may be performed among a plurality of devices. Processes described to be performed by different devices may be performed by one device. Each function to be implemented by a hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor that:
detects occurrence of a request to switch to manual driving during autonomous driving control of a first vehicle, and
presents, in a case where there is occurrence of the request, a part of an explanation about a reason for occurrence of the request, to a driver of the first vehicle.

2. The information processing apparatus according to claim 1, wherein the processor
further performs acquisition of an utterance of the driver in a case where there is occurrence of the request, and
presents, to the driver, a part of the explanation about the reason for occurrence of the request according to the utterance of the driver.

3. The information processing apparatus according to claim 2, further comprising a storage that stores an association between a first utterance and a part of the explanation about the reason for occurrence of the request, wherein
in a case where the utterance of the driver is at least similar to the first utterance, the processor presents, to the driver, the part of the explanation about the reason for occurrence of the request that is associated with the first utterance.

4. The information processing apparatus according to claim 3, wherein
the information processing apparatus is mounted in the first vehicle, and
in a case where there is occurrence of the request, the processor downloads from a predetermined apparatus, and stores in the storage, an association between the utterance of the driver and a part of the explanation about the reason for the occurrence of the request.

5. The information processing apparatus according to claim 4, wherein the processor
further performs acquisition of a cause of occurrence of the request, and
downloads the association according to the cause.

6. The information processing apparatus according to claim 5, wherein the processor collectively downloads the association according to the cause from the predetermined apparatus.

7. The information processing apparatus according to claim 3, wherein
the association includes
a first association associating a plurality of second utterances that are expected in a case of asking for a cause of occurrence of the request, with the cause of occurrence of the request as a part of the explanation about the reason for occurrence of the request, and
at least one second association associating a plurality of third utterances each including a question that is expected to further arise when the cause of occurrence of the request is presented, with an answer to the question as a part of the explanation about the reason for occurrence of the request, and
the processor
presents to the driver, after occurrence of the request, the cause of occurrence of the request that is associated with the second utterance that is similar to an utterance of the driver, by referring to the first association, and
presents to the driver, after presenting the cause of occurrence of the request to the driver, the answer to the question that is associated with the third utterance that is similar to an utterance of the driver, by referring to the at least one second association.

8. The information processing apparatus according to claim 2, wherein
the information processing apparatus is mounted in the first vehicle, and the processor further
transmits the utterance of the driver to a predetermined apparatus, and
receives, from the predetermined apparatus, a part of the explanation about the reason for occurrence of the request according to the utterance.

9. The information processing apparatus according to claim 2, wherein the processor repeatedly performs a process of acquiring the utterance of the driver and presenting a part of the explanation about the reason for occurrence of the request according to the utterance, until the driver starts manual driving.

10. The information processing apparatus according to claim 2, wherein the processor repeatedly performs a process of acquiring the utterance of the driver and presenting a part of the explanation about the reason for occurrence of the request according to the utterance, until acceptance of switching to manual driving is indicated by the utterance of the driver.

11. The information processing apparatus according to claim 9, wherein, in a case where there is occurrence of the request, the processor starts the process of acquiring the utterance of the driver and presenting a part of the explanation about the reason for occurrence of the request according to the utterance, after presenting the request to the driver.

12. A method performed by an information processing apparatus, the method comprising:
detecting occurrence of a request to switch to manual driving during autonomous driving control of a first vehicle; and
presenting, in a case where there is occurrence of the request, a part of an explanation about a reason for occurrence of the request, to a driver of the first vehicle.

13. The method according to claim 12, further comprising
acquiring, by the information processing apparatus, an utterance of the driver in a case where there is occurrence of the request, wherein
the information processing apparatus presents, to the driver, a part of the explanation about the reason for occurrence of the request according to the utterance of the driver.

14. The method according to claim 13, wherein the information processing apparatus
includes a storage that stores an association between a first utterance and a part of the explanation about the reason for occurrence of the request, and
presents to the driver, in a case where the utterance of the driver is at least similar to the first utterance, the part of the explanation about the reason for occurrence of the request that is associated with the first utterance.

15. The method according to claim 14, wherein the information processing apparatus
is mounted in the first vehicle, and
downloads from a predetermined apparatus, and stores in the storage, an association between the utterance of the driver and a part of the explanation about the reason for occurrence of the request, in a case where there is occurrence of the request.

16. The method according to claim 15, wherein the information processing apparatus
acquires a cause of occurrence of the request, and
downloads the association according to the cause.

17. The method according to claim 16, wherein the information processing apparatus collectively downloads the association according to the cause from the predetermined apparatus.

18. The method according to claim 14, wherein
the association includes
a first association associating a plurality of second utterances that are expected in a case of asking for a cause of occurrence of the request, with the cause of occurrence of the request as a part of the explanation about the reason for occurrence of the request, and
at least one second association associating a plurality of third utterances each including a question that is expected to further arise when the cause of occurrence of the request is presented, with an answer to the question as a part of the explanation about the reason for occurrence of the request, and
the information processing apparatus
presents to the driver, after occurrence of the request, the cause of occurrence of the request that is associated with the second utterance that is similar to an utterance of the driver, by referring to the first association, and
presents to the driver, after presenting the cause of occurrence of the request to the driver, the answer to the question that is associated with the third utterance that is similar to an utterance of the driver, by referring to the at least one second association.

19. The method according to claim 13, wherein the information processing apparatus
is mounted in the first vehicle,
transmits the utterance of the driver to a predetermined apparatus, and
receives, from the predetermined apparatus, a part of the explanation about the reason for occurrence of the request according to the utterance.

20. A vehicle comprising the information processing apparatus according to claim 1.
